(19) United States
(12) Patent Application Publication
(10) Pub. No.: US 2004/0168129 A1
(43) Pub. Date: Aug. 26, 2004

(54) Method and apparatus for gathering data and filing a patent application with single-handed and single-digit data entry

(76) Inventor: G. Michael Roebuck, Houston, TX (US)

Correspondence Address: G. Michael Roebuck, 8407 BLUEGATE COURT, HOUSTON, TX, 77025, US

(21) Appl. No.: 10/771,718

(22) Filed: Feb. 3, 2004

Related U.S. Application Data
(60) Provisional application No. 60/449,003, filed on Feb. 24, 2003.

(51) Int. Cl. G06F 17/21

(52) U.S. Cl. 715/530

(57) ABSTRACT

The present invention enables one or a plurality of inventors to enter invention disclosures comprising figures and descriptive text along with patent application support documentation required by the United States Patent Office (USPTO) such as transmittal forms, fee sheets, inventor declarations and assignments into a central document for filing as a patent application. An inventor is guided throw an application development process by answering a series of questions that enable an inventor to provide an enabling disclosure to the USPTO. The central document is periodically filed with the patent office to form the basis for a patent application pursued by a common assignee. A data entry device is provided in data can be entered single-handedly or by use of a single digit of a hand or foot.

### CROSS REFERENCE TO RELATED APPLICATIONS

This patent application claims priority from U.S. provisional patent application serial No. 60/449,003 filed on Feb. 24, 2003 entitled “Method and Apparatus for Gathering Data and Filing a Patent Application with Single-Handed and Single-Digit Data Entry,” by G. Michael Roebuck.

### BACKGROUND OF THE INVENTION

1. Field of the Invention

The present invention relates to the provision a method and apparatus for gathering data to file an aggregate patent application from multiple inventors under a common assignee using automated conversions to generate the specification, claims and drawings required to complete a patent application in accordance with the rules of the U.S. patent office.

2. Background of the Related Art

Typically invention disclosures are solicited from inventors in a corporation or group. The invention disclosures are written up, often tersely and lacking adequate description. The written disclosures are then submitted to a patent review committee for evaluation. Those invention disclosures that are deemed by the patent review committee to have sufficient technical or commercial value are then pursued in a patent application. Often times an inordinate amount of time passes between disclosure solicitation, disclosure write up, patent committee meeting and review and the writing and filing of a patent application. Moreover, good ideas are often lost by misjudgment of an ideas merit by a patent committee, political sabotage or latency of the process enabling another patent to be filed first by a competitor on the same idea. Thus, there is a need for method and apparatus that enables the reduction of the time between an invention disclosure document is written and an application filed. There is also a need for a data entry device that can operated with a single hand or single hand digit without looking at a keyboard to enable a blind or handicapped person to enter data.

Several patents and published patent applications have addressed some aspects of filing a patent application. U.S. Pat. No. 6,049,811, issued on Apr. 11, 2000, by Petruzzi, entitled, “Machine for drafting a patent application and process for doing same,” which is incorporated herein by reference in its entirety, addresses some aspects of the problem of drafting a patent application. U.S. patent publication number 20030196173, published on Oct. 16, 2003 by Petruzzi, entitled, “Machine for drafting a patent application and process for doing same,” which is incorporated herein by reference in its entirety, addresses some aspects of the problem of drafting a patent application. U.S. patent publication 20020072920 published on Jun. 13, 2002, by Grainger, entitled “Computer implemented method of generating information disclosure statements, which is incorporated herein by reference in its entirety, addresses some aspects of the problem of drafting a patent application.

None of the above mentioned patents, however, address the latency between submitting a disclosure and filing a patent application to receive an international priority date, which is enforceable worldwide for the instantiation of intellectual property rights. Moreover, there is a need for a simple data entry device and that enables a user to enter data that allows multiple users to contribute to an aggregate patent application that is filed on the same day to obtain a priority date the same day the data is submitted.

### SUMMARY OF THE INVENTION

The present invention enables one or a plurality of inventors to enter invention disclosures comprising figures and descriptive text along with patent application support documentation required by the United States Patent Office (USPTO) such as transmittal forms, fee sheets, inventor declarations and assignments into a central document for filing as a patent application. An inventor is guided throw an application development process by answering a series of questions that enable an inventor to provide an enabling disclosure to the USPTO and provide a priority date for an invention. The central document is an aggregate of disclosures submitted by each inventor and is periodically (daily, weekly, monthly, annually) filed with the USPTO or another patent office to form the basis for a patent application to be pursued by the inventor(s) or the common assignee. The inventors assign to a common entity as common assignee for filing with the USPTO under the name of the common assignee. A data entry device is provided which can be entered single-handedly or by use of a single digit of a hand or foot.

### BRIEF DESCRIPTION OF THE DRAWINGS

For detailed understanding of the present invention, references should be made to the following detailed description of the preferred embodiment, taken in conjunction with the accompanying drawings, in which like elements have been given like numerals, wherein:

FIG. 1 illustrates a preferred embodiment of the present invention showing a central processor for collecting inventors' input for a patent application filing;

FIG. 2 illustrates a preferred single-handed data entry device provided by the present invention;

FIG. 3 illustrates a preferred single-digit data entry device provided by the present invention;

FIG. 4 illustrates an alternative embodiment of the single-handed data entry device having a single digit data entry device which can be manipulated and tracked for position and speed in three dimensions in combination with data entry keys;

FIG. 5 is a side view of some of the positions to which the single digit data entry device can be manipulated;

FIG. 6 is a side view of some of the positions to which the single digit data entry device can be manipulated;

FIG. 7 is an illustration of a preferred automatic process flow chart generation;

FIG. 8 is an illustration of a preferred automatic apparatus figure generation; and

FIG. 9 is a side view of an alternative embodiment of a data entry device which enables selection of data elements by manipulation of a upper and lower mouth plate with respect to each other vertically and sideways (horizontally) in conjunction with a tongue shroud which is manipulated to additionally select data elements;

FIG. 10 is a top view of the alternative embodiment shown in FIG. 9 showing manipulation of the upper mouth plate with respect to the lower mouth plate sideways in a horizontal plane parallel to the sheet of paper on which FIG. 10 is drawn; and

FIG. 11 is a flow chart showing the functions performed in an illustrative embodiment of the present invention.

### DETAILED DESCRIPTION OF A PREFERRED EMBODIMENT

The present invention enables a single inventor or a plurality of inventors at the same location or separate locations to enter invention disclosures comprising figures and descriptive text along with patent application inventor declarations and assignments into a central aggregate document for filing as an aggregate provisional or utility patent application with the United States Patent and Trademark Office (USPTO) or another patent office outside of the United States. The inventors all assign their rights in the patent to a common assignee for prosecution in the USPTO in the United States or internationally under the Patent Cooperation Treaty (PCT). International patents can be pursued in the USPTO or another foreign patent filing agencies. The central document is periodically filed with the patent office to form the basis for a patent application pursued by the common assignee. The inventors can be co-located in a single facility or be spread out world wide and connected via a communications network such as an intranet or Internet web site. Inventors enter a credit card number or access number for billing of filing or usage fees. Assignments forms are provided to each inventor, which are executed by each inventor and sent to the common assignee via facsimile or scanned and sent to the common assignee electronically. The original inventor assignments are mailed or hand delivered to the common assignee.

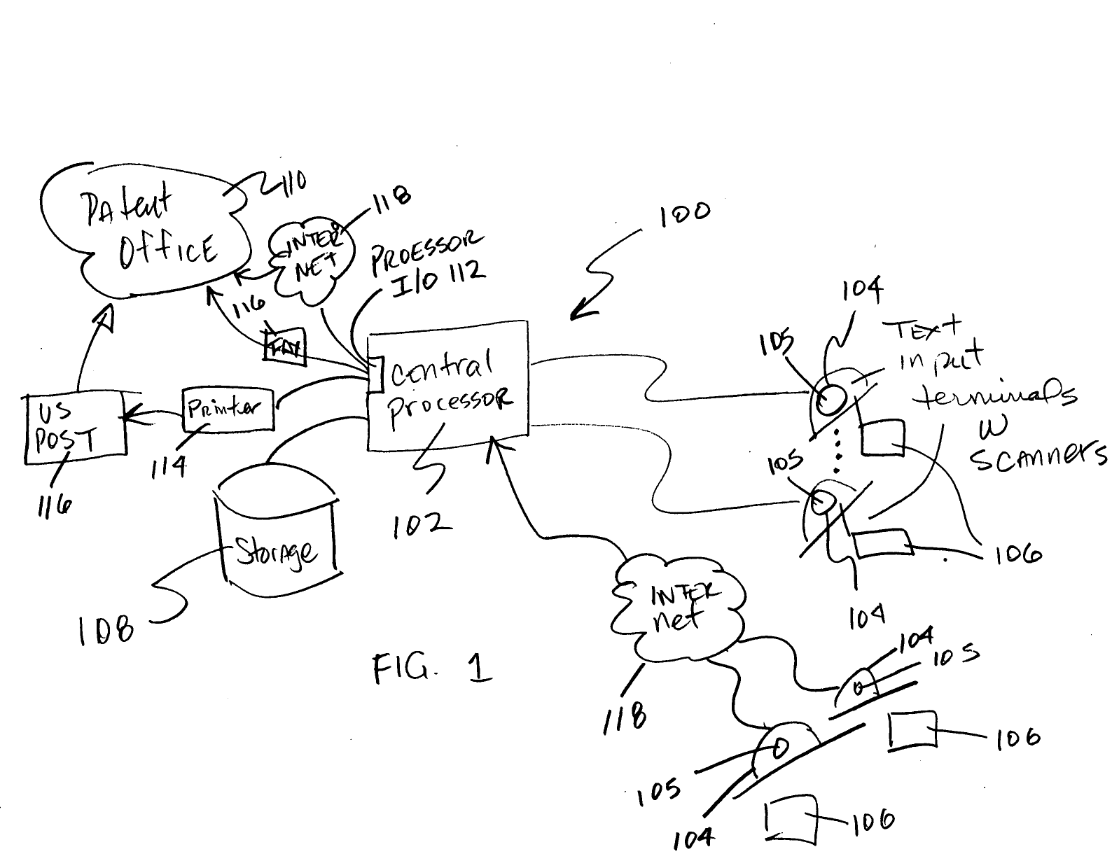

Turning now to FIG. 1, a central processor 102 serves a central data collection point for a plurality of text input terminals 104 with attached scanners/facsimile machines 106. Data input to the central processor 102 is preferably via an intranet or Internet web site. Data are stored on storage device 108. An electronic or paper copy of the aggregate patent application comprising aggregate data comprised of the combination of all input from the inventors from the text input terminals 104 and scanners 106 and automated process flow charts and figures is formatted into a provisional, design or utility patent application. The aggregate patent application and assignments and other filing forms, such as USPTO transmittal forms, are transmitted electronically or mailed via express mail to obtain the current day's filing date, or deposited in U.S. mail for delivery to the USPTO in accordance with USPTO rules or another patent office in any country in the world along with an appropriate filing fees, and supporting documentation required by the national patent office in which the single or aggregate patent application is being filed. For example United States, France, Germany, Japan or Great Britain, the European Patent Office or Patent Cooperation Treaty (PCT) member nation patent office in which the patent application is filed. For example, in the USPTO, inventor's declarations and assignments to a common entity associated with the central processor are submitted for filing as a USPTO application or as a PCT patent application designating the USPTO or other appropriate patent office as the receiving office. The patent application and appropriate supporting documents and fees are sent via regular US mail, Express U.S. mail, electronically via facsimile 116 or email over the Internet 118 via input output (I/O) port 112 to the appropriate patent office or the patent application and appropriate supporting documents and fees are printed on printer 114 and sent via first class or express mail to the appropriate patent office, e.g., USPTO. The present invention utilizes a charge or deposit account with the patent offices to assure payment of necessary fees associated with filing in a timely manner. Patent applications can be filed without a fee, declaration or assignment and abandoned later or these items can be provided later in accordance with the rules of the patent office in which the application is filed.

Supporting documents, such as inventor declarations, powers of attorney and assignments are presented to the inventor as forms for signature, execution and dating by the inventor or inventors for filing along with the patent application. A sole inventor and joint inventor declaration declaring that the inventor as a sole inventor of the subject matter disclosed in the patent application and joint inventor the subject matter invention, as appropriate, a power of attorney naming an agent associated with the common assignee as agent for prosecution of the patent application and assignment from each of the inventors to an entity associated with the central processor web site are presented to and executed by each inventor.

Preferably, a list of questions are presented to the inventor at text input terminal display 105. The questions may also be verbal queries to which the inventor responds verbally. In this case the processor generates verbal responses from the list of textual questions and translates the inventor's verbal responses to text for input into a single or aggregate patent application. Drop down displays are provided to explain the standards, for example, what constitutes an enabling disclosure under 35 USC 112 in the USPTO, the parts required in a patent application, e.g., a claim, specification, drawing, abstract and fee to get a filing date, to which the inventor is to comply in accordance with any patent office to which the patent application will be sent in any PCT state. The present invention automatically generates the required parts of the patent application (assignment, specification, claims, abstract, cross reference to related applications, figures, flow charts, brief description of the figures and summary of the invention) from responses solicited from the inventor during a query session. The questions or queries guide the inventor through the disclosure process and enable an inventor, unfamiliar with the patent application process and drafting requirements, to complete an enabling disclosure with all parts, text, forms, figures and fees necessary and sufficient to establish generate a provisional, utility or design patent application to obtain a priority date in the USPTO and PCT member states.

Inventors need not understand how to comply with tedious rules of the patent offices and can simply describe the idea as best they can as a process without having to draft a claim or generate a drawing and receive a filing date in the USPTO or other patent office the same day they enter the data to the method and apparatus of the present invention. The common assignee is located in Hawaii so that a filing date is obtained at the latest possible time before midnight on the day the invention is filed. Inventors can provide as much or as little detail as they desire but are advised that only descriptions that enable a person to make and use the invention describes will likely provide the necessary enabling disclosure required by the patent office. Inventors are advised that figures are typically required to provide an enabling disclosure from which a utility patent application can be based for an apparatus. Figures and flow charts are automatically generated by present invention in response to a query session with the inventor(s). Inventors also have the option of submitting a scanned hand-drawn figure or electronic representation of a figure showing their invention. A fill in the blank flow chart is provided for an inventor to draw a flow chart describing a process for a process patent application.

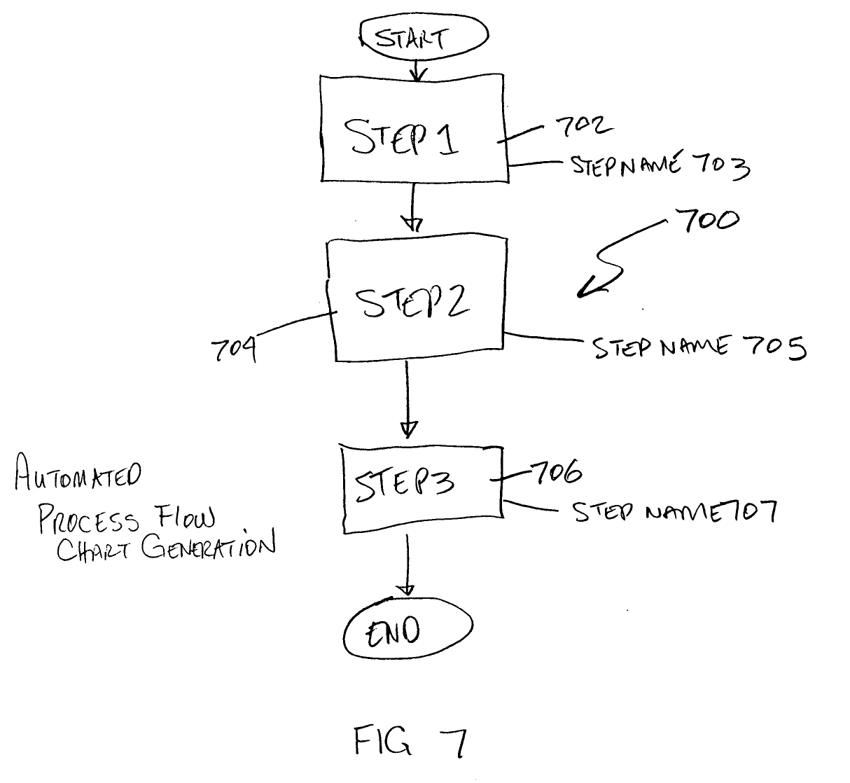

In an illustrative embodiment, the inventor is asked how many steps are performed in the process and asked to describe each step in the process. The inventor is also asked to name each step in the process. Each step name is placed beside the corresponding flow chart box 703, 705 and 707. The description of the step, requested to comprise 10 words or less, is placed in the corresponding flow chart box 702, 704 and 706, with each successive method step described in each box flowing to the next successive flow chart step (box) to box in the flow chart. As shown in FIG. 7, a three-step method would place step one in box one 702, step two in box two 704 and step three in box three 706. Step one's name 703 is placed beside box one 702, step two's name 705 is placed beside box two 704 and step three's name 707 is placed beside box three 706. As stated, the inventor is asked to name and describe each successive step to automatically generate the flow chart or process step performance chart. The step box names, step box reference numerals, the description of each step box and the interactions of each step box with every other step box are also generated from the query session and placed in the specification of the patent application. A claim containing the step boxes which the inventor deems critical to the application is automatically generated using a preamble solicited in a query from the inventor or using the title of the invention as a preamble for the method claims. A form paragraph is used to establish the basis for a computer readable medium claim (Bouregard claim) and data base claims (Lowry claims) is inserted into the specification and used to automatically generate computer readable medium and data base claims from the method claims. Additional queries to the inventor are made available to further articulate and automatically generate the computer readable medium claim (Bouregard claim) and data base claims (Lowry claims).

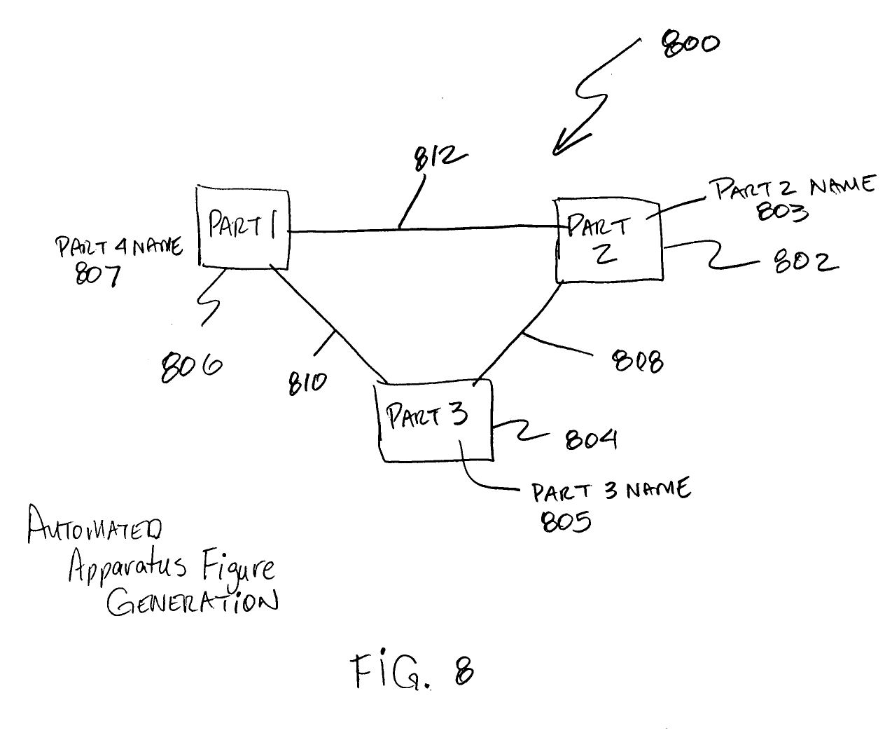

A generic apparatus figure is also generated automatically for filing with apparatus invention with a caption using the title of the invention as shown in FIG. 8. As shown in FIG. 8, during a query session, an inventor will be asked to describe the component parts of the invention and to name each part. In an illustrative embodiment, the inventor is asked how many parts make up the apparatus. The inventor is asked limit the number of parts to 10 parts per figures unless more figures and part are deemed necessary by the inventor. The inventor is then asked to name and describe each part in the apparatus and how each part interacts with each of the other parts. Each part of the apparatus is given a box. Each part name 803, 805, 807 is placed beside the corresponding part box 802, 804 and 806. The description of the part, requested to comprise 10 words or less, is placed in the corresponding part box 802, 804 and 806, with each part box connected to each other part box with which it interacts. The part box names, part box reference numerals, the description of each part box and the interactions of each part box with every other part box are also generated from the query session and placed in the specification of the patent application. A claim containing the part boxes which the inventor deems critical to the application is automatically generated using a preamble solicited in a query from the inventor or using the title of the invention as a preamble for the apparatus claim. The boxes for the apparatus figures and method figures are generated by a commercially available drawing package such as Microsoft® VISIO® of other drawing software package well known in the art and running on the processor provided by the present invention.

In FIG. 8, in response to queries to the inventor and response thereto by the invention, a figure is drawn for filing with the patent application. As shown in FIG. 8, the queries to the inventor, the responses, and the figure generated there from indicates that part 1 interacts with parts 2 and 3, thus a line 812 is drawn between parts 1 and 2 and a line 810 is drawn between parts 1 and 3. Part 3 interacts with parts 1 and 2, thus a line 812 is drawn between parts 1 and 3 and a line 808 is drawn between parts 2 and 3. As shown in FIG. 8, a three-part apparatus would place part one description in box one 806, part two description in box two 802 and part three description in box three 804. Part one's name 807 is placed beside box one 802, part two's name 805 is placed beside box two 804 and part three's name 808 is placed beside box three 806.

In a preferred embodiment, during an automatic query session during development of the single or aggregate patent application, each inventor is asked to describe the problem solved, the solution to the problem and how to implement the solution. Each inventor is also asked to provide a drawing illustrating the problem, the solution and the components of the solution. Each solution is described as a method and as an apparatus. The inventor's input is used to generate a method claim, such as, a method for solving the problem described implementing the solution provided, and an apparatus for solving the problem described implementing the solution provided.

Each inventor is also asked to fill out and execute, manually and scanned in or electronically, a declaration as sole inventor or co-inventor, power of attorney naming an inventor associated with the common assignee with power of attorney and an assignment for the invention submitted and all forms necessary for obtaining a filing date for utility and provisional patent application in the USPTO or another patent offices which are PCT states. Each patent application is filed as a single patent application and/or as an aggregate patent application along with the documents generated during the patent generation session. All single patent applications are combined into an aggregate patent application along with all figures from all inventors are joined together and filed periodically along with the supporting declarations, assignments and powers of attorney and filed with the USPTO. Preferably, all inventors' names appear on the patent cover sheet and patent transmittal forms. In a preferred embodiment, the inventors inputs is captured and combined into an aggregate patent application with all figures and supporting documents (declarations, powers of attorney, assignments) scanned in and automatically generated and filed daily. Figures are given successive numbers in and correlated with the corresponding disclosure so that the text describing an invention and the figure numbers correlate and correspond. For example if two inventors 1 and 2, both describing separately a set of six figures named FIGS. 1-6 using reference numerals 100-699, FIGS. 1-6 are automatically generated for inventor 1. The description and figures associated with inventor 1 are designated as FIGS. 1-6 and reference numerals 100-699. The description and figures associated with inventor 2 are designated FIGS. 7-12 and 700-1299 instead of FIGS. 1-6 to avoid confusion with the description and figures associated with inventor 1. A third inventor's figures would then use figure numbers starting at FIG. 13 and reference numbers starting at 1300 to avoid confusion with the description and figures associated with inventors 1 and 2.

The aggregate patent applications are filed daily, thus, the inventor can file the same day he discloses. Worst case there is not more than a 24-hour latency between a disclosure query session and filing an application to receive an international priority date in the USPTO.

The filed aggregate patent application, comprising all inventor inputs can be reviewed later by each inventor or a patent review committee to determine what changes need to be made and whether or not to pursue some, all or none of the ideas described in the aggregate patent application. Data and figures deemed not relevant to the pursued patents can be redacted or removed from the provisional or prior utility or design patent filed. In an amendment or later filed patent application, claims can be written bridging or combining ideas from separate inventors. In one embodiment a group of inventors can brain storm an idea in a group setting and submit a transcript of the brain storming session along with figures and supporting declarations, assignments and powers of attorney as a patent application to be filed with the USPTO the same day the inventors meet by conducting a query session with the illustrative example of the method and apparatus of the present invention.

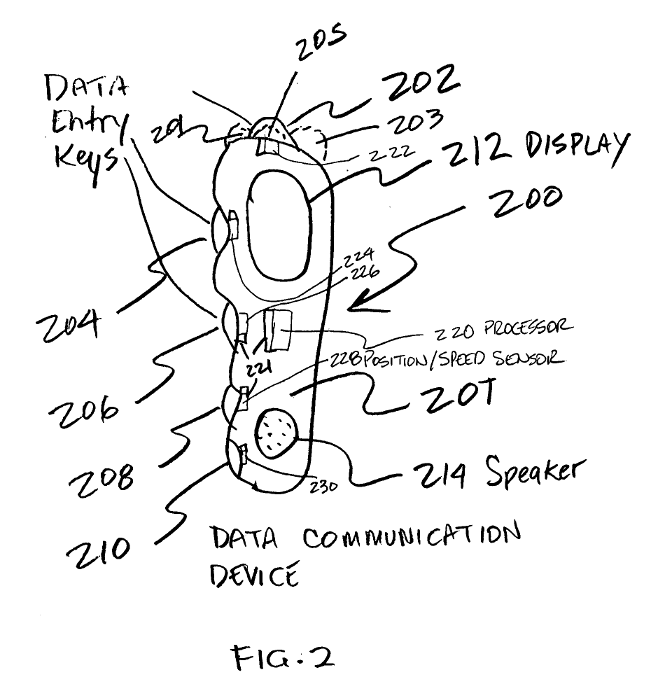

Turning now to FIG. 2, in an alternative embodiment, a one-handed data communication device 200 is provided whereby a plurality of data entry keys 202, 204, 206, 208 and 210 are provided for coded input of alphanumeric data, icons, pictures, graphics, symbols, signals, phrases, words or data are provided. The different combinations of switch positions are assigned to different data elements. The device body 207 fits into a person's hand. Key 202 is toggle mounted to accommodate movement by a person's thumb, finger, toe, tongue or other appendage forward into position 201 or backward into position 203. Key 202 can also be depressed downward into position 205. Keys 204, 206, 208 and 210 are preferably depressed represent for example 2⁴-1 (15) combinations when key 202 is in position 201, a different 15 combinations when key 202 is in position 203 and yet another different and unique 15 combinations when key 202 is in position 205. Thus, the device 200 can be utilized to represent 45 combinations, which can be assigned to correspond to any data group of 45 data items including the 26 letters of the alphabet and digits 0-9 and 9 additional special characters. The position of keys 202, 204, 206, 208 and 210 can be detected on a continuum so that the number of data elements represented by the combination of the detected positions of keys 202, 204, 206, 208 and 210 is limited only by an operator's ability to discretely position keys 202, 204, 206, 208 and 210 to represent a data element. Keys 202, 204, 206, 208 and 210 are each associated with a position and speed sensor to detect the position and speed of each keys individually on a continuum. The continuum is typically divided into one or more discrete steps for each key to make the keys easy to operate. The sensitivity of each of keys 202, 204, 206, 208 and 210 is determined by the number of steps into which the movement of each key 202, 204, 206, 208 and 210 is divided. The advantage of the one handed date communication device is that it enables a no look, single handed dialing and data entry for use in association with a cell phone or any other data communication device. Thus, a person can dial, answer and operate a cell phone of other personal data communication device while driving a car or performing some other activity without looking at a keypad. The data communication device also comprises a display 212 and sound generator 214.

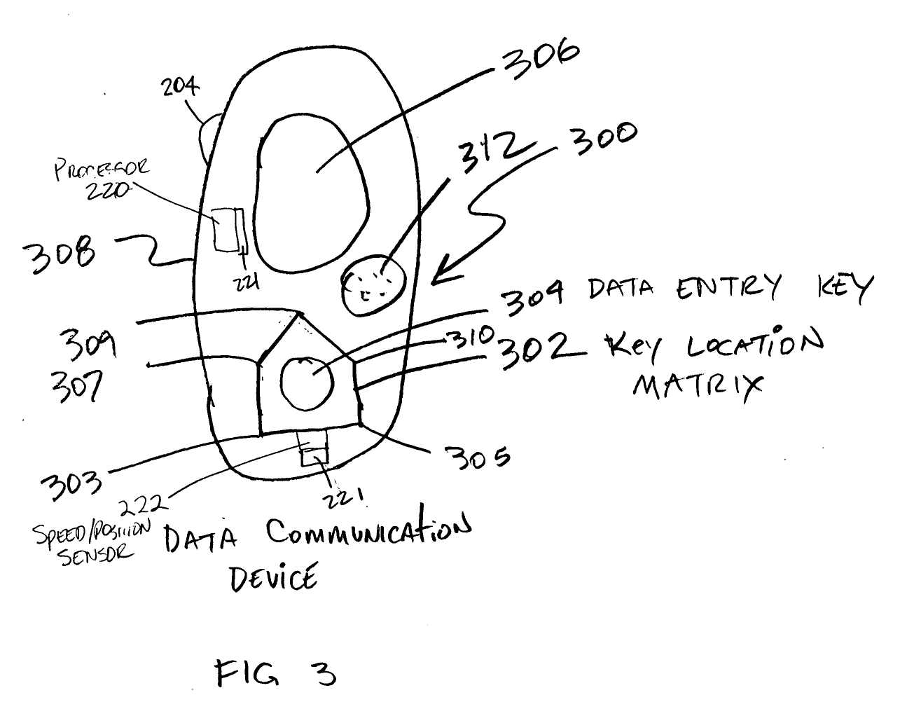

Turning now to FIG. 3, an alternative embodiment of the data communication device is illustrated having a single data entry key 304, which can be depressed and moved to within key location matrix 302 to encoded key location zones 303, 305, 307, 309 and 310. The key location matrix 302 can also be shaped as a square, triangle, trapezoid, rhombus or parallelogram. Each encoded key location zone is mapped to or associated with and represents a particular data item. A combination of movement of the data entry key to an encoded key location zone and depression of the data entry key 304 or once, twice or more times represent additional unique combinations and is mapped to and represents additional data items. For example, each of the five encoded key location zones 303, 305, 307, 309 and 310 can be mapped to represent the numbers 0-4, while in an encoded key location zones 303, 305, 307, 309 and 310 in combination with a depression of data key 304 or key 204 can be mapped to represent the numbers 5-9 to enable dialing a cell phone or entry of numbers 0-9 with only a single digit, for example, a thumb and without looking at a key pad. Addtionally, each of the five encoded key location zones 303, 305, 307, 309 and 310 in combination with a single depression of data key 304 or key 204 can be mapped to represent the numbers 0-4, while in an encoded key location zones 303, 305, 307, 309 and 310 in combination with a double depression of data key 304 or key 204 can be mapped to represent the numbers 5-9 to enable dialing a cell phone or entry of numbers 0-9 with only a single digit, for example, a thumb and without looking at a key pad. The duration of the key 304 in a key location zone can represent a digit as well. That is, the data communication device is also provided with a display 306 and sound generator 312 to confirm numbers or data items decoded as they are entered by the user using the data communication device 300. Additional key positions can be encoded to represent answering a call, ending a call and speed dialing using a combination of position entries executed by keys 202, 204, 206, 208 and 210.

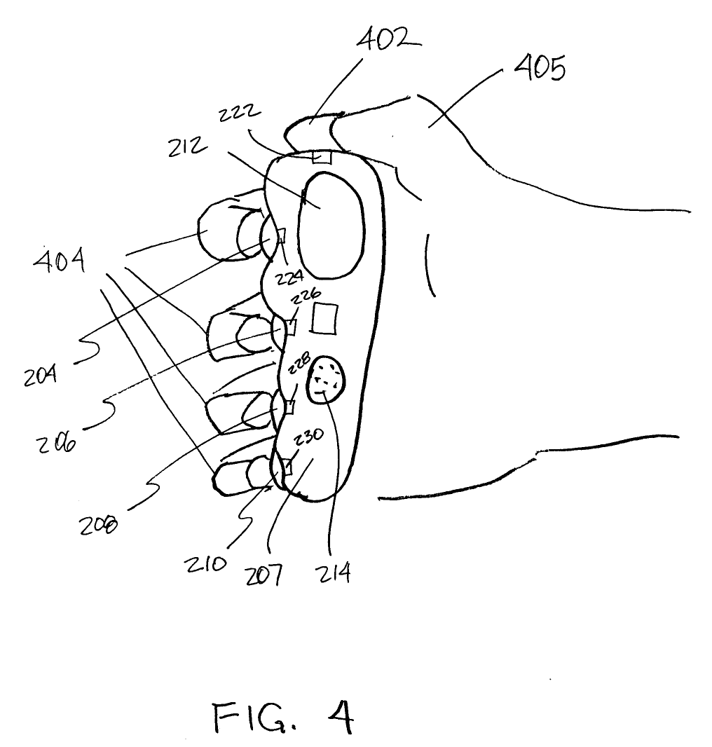

Turning now to FIG. 4 a side view of an alternative embodiment of the present invention is illustrated showing data shroud 402, which enables manipulation of an input key in three dimensions. Unlike a simple key, the shroud enables a single digit of a hand or foot to exert force on the shroud and an associated position sensitive element to move the shroud and enable the position sensitive element to sense movement of the digit and digit shroud in three dimensions in an x, y and z space relative to the longitudinal axis of the data entry device. Thus the data shroud can be manipulated up, down, forward, backward and sideways. The data shroud can even be manipulated by a person's tongue in the case where a person does not have use of their hands for feet. The structure of the data shroud is fashioned to fit the application for which it is intended. A series of discrete three-dimensional positions can be decoded to represent a data element for use by persons with limited abilities to manipulate to many discrete positions thus enabling representation of a large number of data elements by a limited number of discrete positions. The resolution of the position sensitive can be selected to sense continuous movement or discrete movements by speed position sensor 222, 224, 226, 228 230 and associated processor 220 as shown in FIGS. 2, 3, 4, 5 and 6. Each incremental movement and the speed of movement of the data shroud 402 and keys 202, 204, 206, 208, 210, 304 is decoded during operation for association a data set. The combination of positions of the data shroud 402 and keys 202, 204, 206, 208, 210, 304 are associated with an encoded data set. The encoded data set can represent virtually any type of aural, visual, textual items in three dimensions which can be icons; graphics; pictures; sounds; words, sentences, phrases in any language associated with a translator; and alphanumeric characters or numbers. The data shroud and keys are also useful for navigating in a three or more dimension, multi-dimensional database.

The positions of the data shroud 402 and keys 202, 204, 206, 208, 210, 304 can also be used to draw or create data elements such as computer aided designs figures and drawings by tracking the positions speed and duration of data shroud 402 and keys 202, 204, 206, 208, 210, 304 in three dimensions. The positions of the data shroud 402 and keys 202, 204, 206, 208, 210, 304 can also be used to navigate within a three dimensional data space such as a computer aided design drawing or a three dimensional data base.

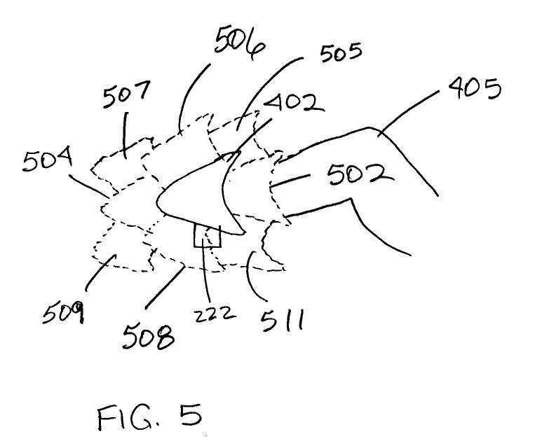

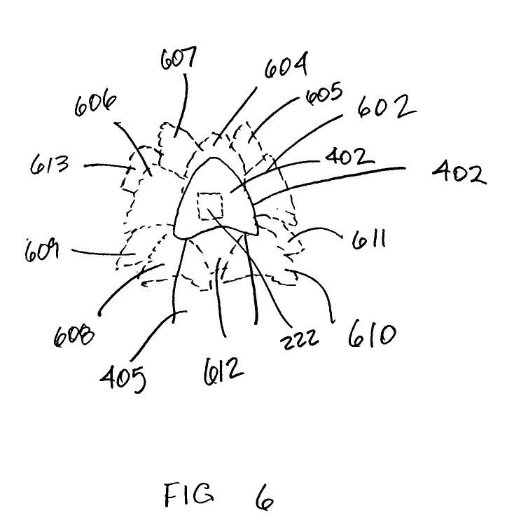

The encoded positions of the data shroud 402 or the positions of key 202 are used by themselves to select and enter data or can be combined with date entry keys 204, 206, 208 and 210 to encode an expanded set icons; graphics; pictures; sounds; words, sentences, phrases in any language when associated with a translator; pixels, data elements in three dimensions, three dimensional points in any three dimensional representation and alphanumeric characters or numbers. As shown in FIG. 5, a top view of the data shroud is shown in different positions to which the data shroud can be manipulated up and down into positions 506 and 508 respectively, as well as backward and forward 502 and 504 respectively. The shroud can also be manipulated up and forward to position 507, forward and down to position 509, backward and down to position 511 and backward and upward to position 505. Turning now to FIG. 6 a top view of shroud 402 showing 6 major manipulation positions forward 604, forward right 602, backward right 610, backward 612, backward left 608, forward left 606 and positions in between 605, 611, 609 and 613. The degree of movement of the data shroud is tracked on a continuum in three-dimensional space so that the degree of movement of the data shroud is representative of all three dimensional space. The positions shown in FIG. 5 and FIG. 6 and the intermediate positions there between are combined to form a unique position in three-dimensional space associated with a unique data element, data position or data item. The three-dimensional position is combined with other data keys to further identify additional data elements mapped to the combinations selected by the three-dimensional positions combined with the other data keys.

The degree of movement, up, down, forward, backward and sideways of the data shroud is detectable on a continuum in three dimensions so that the number of positions in a three dimensional space are virtually unlimited and its ability to map to a data set by itself for in combination with other data keys is only limited by the operator's ability to discretely position the data shroud to a desired position associated with a particular data element. The data shroud also operates in attack mode where the speed of the movement is detected and associated with a data element. For example, one or more octaves representing the keys of a piano can be associated with a set of data shroud positions so that the speed at which a user moves to a position represents the attack or force with which a piano player strikes a piano key and the decoded data shroud note are reproduce by the sound generator accordingly, adjusting the amplitude and sustain in accordance the speed at which the data shroud moves to a note position. The data keys can be programmed to represent attack as well and used in conjunction with the data shroud to represent a data set and data set element characteristics. The data shroud speed of movement and position or data keys can also be used to represent inflections in speech or language decoded from positions selected by the data shroud or data keys.

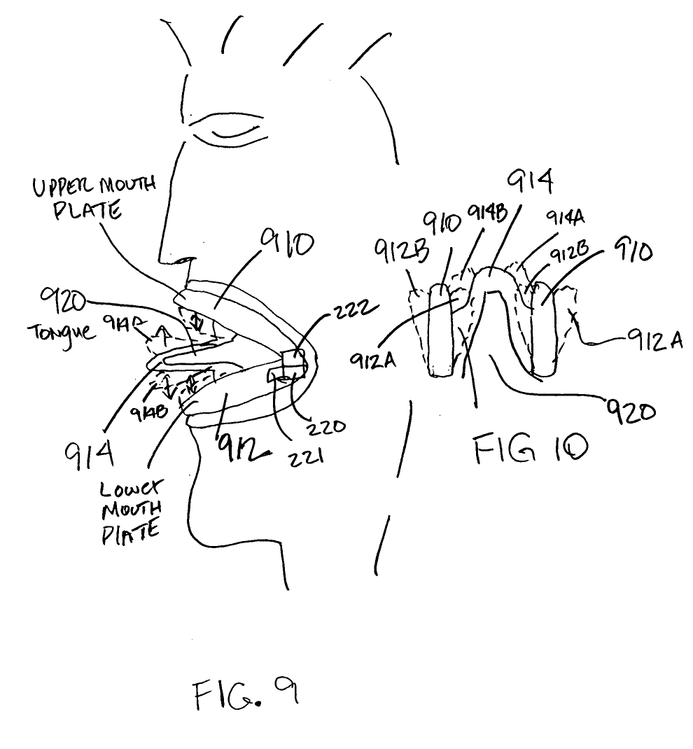

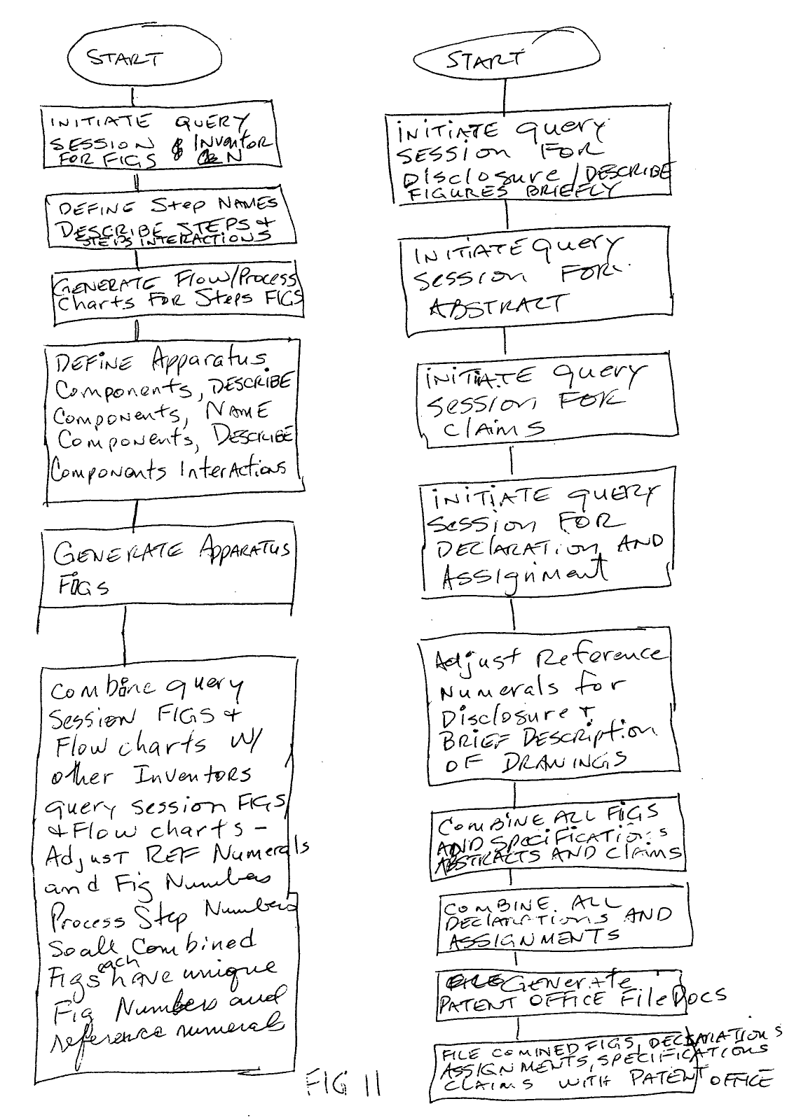

Turning now to FIG. 9 and FIG. 10, FIG. 9 is a side view of an alternative embodiment of a data entry device which enables selection of data elements by manipulation of a upper and lower mouth plate with respect to each other vertically and sideways (horizontally) in conjunction with a tongue shroud which is manipulated to additionally select data elements and FIG. 10 is a top view of the alternative embodiment shown in FIG. 9 showing manipulation of the upper mouth plate with respect to the lower mouth plate sideways in a horizontal plane parallel to the sheet of paper on which FIG. 10 is drawn.

FIG. 9 illustrates the mouthpiece data entry device where by an upper mouth plate 910 securely fits over a person's upper teeth and a lower mouth plate 912 securely fits over a person's lower teeth, somewhat like a protective mouthpiece worn by athletes. The upper and lower mouth plates are moved vertically with respect to each other by opening and closing of the mouth. The upper and lower mouth plates are moved sideways or horizontally with respect to each other by displacing the lower jaw sideways with respect to the upper teeth. The displacement of the upper and lower mouth plates vertically and horizontally with respect to each other are combined with manipulation vertically and sides of tongue shroud 914 by tongue 920. Note when lower plate 912 is displaced left of upper plate, lower plate assumes position 912B and when lower plate 912 is displaced right of upper plate, lower plate assumes position 912A as shown in FIG. 10. The combination of movements of upper and lower mouth plates and tongue shroud 914 are encoded and mapped to a data element set as described above using a position speed sensor 222 and processor 220. All speed and position sensors 222, 224, 226, 228 and 230 send data to processor 220 via data communication devices send data via a wireless transmitter or direct connection from input output devices 221 associated with processor 220. Processor 220 communicates speed and position data or decoded data elements associated with speed and position data to external processors via data communication devices, which send data via a wireless transmitter or direct connection from input output devices 221 associated with processor 220.

In another embodiment, the method of the present invention is implemented as a set computer executable of instructions on a computer readable medium, comprising ROM, RAM, CD ROM, Flash or any other computer readable medium, now known or unknown that when executed cause a computer to implement the method of the present invention.

While the foregoing disclosure is directed to the preferred embodiments of the invention various modifications will be apparent to those skilled in the art. It is intended that all variations within the scope of the appended claims be embraced by the foregoing disclosure. Examples of the more important features of the invention have been summarized rather broadly in order that the detailed description thereof that follows may be better understood, and in order that the contributions to the art may be appreciated. There are, of course, additional features of the invention that will be described hereinafter and which will form the subject of the claims appended hereto.

What is claimed is:

1. A method for drafting a patent application comprising:
performing a first query session with an inventor to define elements of a first subject matter; and
generating a first patent specification based on the first subject matter defined elements.

2. The method of claim 1 further comprising:
filing a patent application based on the first patent specification.

3. The method of claim 1, further comprising:
drawing a first figure based on the first subject matter defined elements.

4. The method of claim 1, further comprising:
conducting a second query session with an inventor to define elements of a second subject matter;
drafting a second patent specification based on the second subject matter defined elements; and
combining the first and second patent specifications.

5. The method of claim 4, further comprising:
drawing a second figure based on the second subject matter defined elements.

6. The method of claim 5, further comprising:
adjusting reference numerals in the first figure and the second figure so that each figure has unique reference numerals associated with elements shown in the figures.

7. The method of claim 4, further comprising:
adjusting reference numerals in the first specification and the second specification so that each specification has unique reference numerals associated with elements defined in the specification.

8. The method of claim 7, further comprising:
adjusting the reference numerals in the second specification so that the lowest reference numeral in the second specification is greater than the highest reference numeral in the first specification.

9. The method of claim 6, further comprising:
adjusting the reference numerals in the second figure so that the lowest reference numeral in the second figure is greater than the highest reference numeral in the first figure.

10. The method of claim 8, further comprising:
adjusting the reference numerals in the second figure to match the adjusted reference numerals in the second specification.

11. The method of claim 3, further comprising:
generating a process flow chart.

12. The method of claim 3, further comprising:
generating an apparatus figure.

12. The method of claim 1, further comprising:
wherein the subject matter comprises a process.

13. The method of claim 1, further comprising:
wherein the subject matter comprises an apparatus.

14. The method of claim 1, further comprising:
conducting a query session to generate an assignment for filing with the patent application.

15. The method of claim 4, further comprising:
conducting a query session to generate an assignment for filing with the combined patent application.

16. The method of claim 1, further comprising:
receiving an assignment to a common entity from the inventor for filing with a patent application.

17. The method of claim 4, further comprising:
receiving an assignment to a common entity from the second inventor for filing with a patent application.

18. A method for drafting a patent application comprising:
performing a first query session with an inventor to define elements of a first subject matter;
generating a first patent specification based on the first subject matter defined elements.
drawing a first figure based on the first subject matter defined elements.
conducting a second query session with an inventor to define elements of a second subject matter;
drafting a second patent specification based on the second subject matter defined elements;
combining the first and second patent specifications;
drawing a second figure based on the second subject matter defined elements;
adjusting reference numerals in the first figure and the second figure so that each figure has unique reference numerals associated with elements shown in the figures;
adjusting reference numerals in the first specification and the second specification so that each specification has unique reference numerals associated with elements defined in the specification;
adjusting the reference numerals in the second specification so that the lowest reference numeral in the second specification is greater than the highest reference numeral in the first specification;
adjusting the reference numerals in the second figure so that the lowest reference numeral in the second figure is greater than the highest reference numeral in the first figure;
adjusting the reference numerals in the second figure to match the adjusted reference numerals in the second specification;
generating a process flow chart;
generating an apparatus figure;
receiving an assignment to a common entity from the inventor for filing with a patent application; and
receiving an assignment to a common entity from the second inventor for filing with a patent application.

19. A computer readable medium containing instructions that when executed by a computer perform the steps of:
performing a first query session with an inventor to define elements of a first subject matter;
generating a first patent specification based on the first subject matter defined elements.
drawing a first figure based on the first subject matter defined elements.
conducting a second query session with an inventor to define elements of a second subject matter;
drafting a second patent specification based on the second subject matter defined elements;
combining the first and second patent specifications;
drawing a second figure based on the second subject matter defined elements;
adjusting reference numerals in the first figure and the second figure so that each figure has unique reference numerals associated with elements shown in the figures;
adjusting reference numerals in the first specification and the second specification so that each specification has unique reference numerals associated with elements defined in the specification;
adjusting the reference numerals in the second specification so that the lowest reference numeral in the second specification is greater than the highest reference numeral in the first specification;
adjusting the reference numerals in the second figure so that the lowest reference numeral in the second figure is greater than the highest reference numeral in the first figure;
adjusting the reference numerals in the second figure to match the adjusted reference numerals in the second specification;
generating a process flow chart;
generating an apparatus figure;
receiving an assignment to a common entity from the inventor for filing with a patent application; and
receiving an assignment to a common entity from the second inventor for filing with a patent application.

20. An apparatus for drafting a patent application comprising:
means for performing a first query session with an inventor to define elements of a first subject matter;
means for generating a first patent specification based on the first subject matter defined elements.
means for drawing a first figure based on the first subject matter defined elements;
means for conducting a second query session with an inventor to define elements of a second subject matter;
means for drafting a second patent specification based on the second subject matter defined elements;
means for combining the first and second patent specifications;
means for drawing a second figure based on the second subject matter defined elements;
means for adjusting reference numerals in the first figure and the second figure so that each figure has unique reference numerals associated with elements shown in the figures;
means for adjusting reference numerals in the first specification and the second specification so that each specification has unique reference numerals associated with elements defined in the specification;
means for adjusting the reference numerals in the second specification so that the lowest reference numeral in the second specification is greater than the highest reference numeral in the first specification;
means for adjusting the reference numerals in the second figure so that the lowest reference numeral in the second figure is greater than the highest reference numeral in the first figure;
means for adjusting the reference numerals in the second figure to match the adjusted reference numerals in the second specification;
means for generating a process flow chart;
means for generating an apparatus figure;
means for receiving an assignment to a common entity from the inventor for filing with a patent application; and
means for receiving an assignment to a common entity from the second inventor for filing with a patent application.
